(19) United States
(12) Patent Application Publication
(10) Pub. No.: US 2026/0332696 A1
(43) Pub. Date: Oct. 22, 2026

(54) METHOD AND SYSTEM FOR HANDLING ACTIVE VOICE COMMUNICATIONS IN REAL-TIME

(71) Applicant: SymmetriCall Inc., Miami, FL (US)

(72) Inventors: Kenneth Chad Venables, Las Vegas, NV (US); Scott David Hazard, Pinecrest, FL (US)

(21) Appl. No.: 19/340,481

(22) Filed: Sep. 25, 2025

Related U.S. Application Data
(60) Provisional application No. 63/791,244, filed on Apr. 18, 2025.

(51) Int. Cl. H04M 3/22; H04L 65/403; H04M 3/523

(52) U.S. Cl. CPC H04M 3/2254; H04L 65/403; H04M 3/5231

(57) ABSTRACT

System, non-transitory computer readable storage medium, and method for real-time handling of active voice communications are disclosed. The method can include receiving a plurality of voice communication requests from user devices; generating UI data comprising communication request information associated with the plurality of voice communication requests; transmitting the UI data to agent devices, where a UI is presented on each of the agent devices based on the UI data, the UI comprises a plurality of selectable UI components corresponding to the plurality of voice communication requests, and each UI component includes communication request information associated with a corresponding voice communication request; and initiating a first active voice communication, for a first voice communication request, between a first user device and a first agent device in response to receiving a service request from the first agent device to service the first voice communication request.

### CROSS-REFERENCE TO RELATED APPLICATIONS

This application claims the benefit of U.S. Provisional Application No. 63/791,244 filed on Apr. 18, 2025, the disclosure of which is incorporated herein by reference.

### TECHNICAL FIELD

This application generally relates to management of concurrent and non-concurrent (individual, isolated) phone calls (VoIP) and other interactive communication between user devices. More specifically, this application is related to method and system for handling active voice communications in real-time.

### BACKGROUND

Small businesses frequently rely on a reduced number of cellphones, occasionally only one. In many cases, voice calls placed with these devices make use only of features provided by cellphone manufacturers and the carrier. No software-enabled business communications service is used. In such cases, it is common for the same device to be used for both business and personal calls.

Employees, or in some cases, members of the family of a business owner use their own phones for calls related to the business, although there often is a “main” number and/or device belonging to the business owner. One problem that exists in such situations is that a business owner may not know, when their phone rings, whether the call is personal or relates to their business. In particular, they often have no way of identifying unwanted “spam” calls or priority clients from an incoming call.

In other cases, professional software-enabled voice communication (also referred to as “softphone”) and automated processing of calls used by small businesses are not answered by a human. This software-enabled automated call processing is more sophisticated than a simple voicemail box, often involving at least an IVR (Interactive Voice Response) system that can include a menu and collect information from a caller using the keypad (touch-tone) or by processing verbal responses from a caller.

Even in those cases, business owners and their employees face situations where multiple callers try to access the business within the same short time frame (concurrent calls). The callers, therefore, can immediately be directed to the IVR. For the business team, it is common for them to know only that the phone is ringing: one or more people are calling. If it is more than one caller, they often have no way of knowing the quantity of concurrent calls, such as five or five thousand calls. A large fraction of concurrent calls can be routed into the IVR queue. It is difficult or impossible for respondents to know whether a call is important as there often is no caller identification. The calls are generally taken up in the order received, leaving important calls in the IVR for long periods of time. This is a consequence of the architecture of existing private automatic branch exchange (PABX) systems, which direct serial engagement of incoming calls. Such systems are limited by physical phone line locations and counts.

### BRIEF DESCRIPTION OF THE DRAWINGS

FIGS. 1A-1B are diagrams illustrating an example interactive communication system that enables parallel processing of incoming voice communications according to an embodiment.

FIGS. 2A-2D are diagrams illustrating examples of different voice communication scenarios according to an embodiment.

FIG. 3 is a diagram illustrating the management of multiple voice communications according to an embodiment.

FIGS. 4A-4B are diagrams illustrating example visual representations of voice communications displayed on an agent device according to an embodiment.

FIG. 5 is a diagram illustrating an example of a voice communication record according to an embodiment.

FIG. 6 is a flow diagram illustrating a process of processing voice communications according to an embodiment.

FIGS. 7A-7B are flow diagrams illustrating timelines for examples of voice communication instances (“calls”) according to an embodiment.

FIGS. 8A-8C are diagrams illustrating example information associated with voice communications displayed on an agent device according to an embodiment.

FIG. 9 is a diagram illustrating the handling of dropped voice communications according to an embodiment.

FIG. 10 is an embodiment of a computer system that may be used to support the systems and operations discussed herein.

### DETAILED DESCRIPTION

In the following description, numerous details are set forth. It will be apparent, however, to one of ordinary skill in the art having the benefit of this disclosure, that the embodiments described herein may be practiced without these specific details. In some instances, well-known structures and devices are shown in block diagram form, rather than in detail, in order to avoid obscuring the embodiments described herein.

Some portions of the detailed description that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The embodiments discussed herein may also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the embodiments discussed herein are not described with reference to any particular programming language. It will be appreciated that a variety of programming languages may be used to implement the teachings as described herein.

According to some embodiments, a system is disclosed whereby incoming voice communications (e.g., phone calls) may be made dynamically available to a group of agents to enable call transparency and accessibility to said group for the duration of the call. Compared to existing voice communication systems, the system described herein provides improved call management and organization solutions that enable optimal teamwork by agents and managers at the business receiving the call, so that important calls are not missed. For example, parallel processing of inbound calls, in contrast with legacy serial handling of queued callers, may allow all available agents to answer any inbound call before it enters an interactive voice response system (IVR). Any call not answered by an agent may be connected to an IVR system. Free or available agents may be enabled to pull and answer any call from the queue, which includes unanswered inbound calls as well as calls already connected to the IVR. In an embodiment, a customer placing a call to the enterprise may perceive their call as “ringing” for an initial period before either being answered by an agent or being connected to the IVR. In an embodiment, agents at the enterprise may have the opportunity to answer inbound calls during the time interval which precedes connection to the IVR. As noted elsewhere, agents may also have the ability to view information about a call being handled by IVR (including call duration, information provided by caller, history within menu system, voice transcript) and then, should they so choose, to answer that call. In that case, the customer experiences a transition from interacting with the IVR to speaking with an agent who has access to information already provided by the customer via the IVR. For the case of voice communication (or calls), calls not yet answered by a human are said to be “queued” or “in a queue”. This includes inbound calls that are still ringing, which may be answered by an available agent. The queue (or “backlog”, “real time load”) also includes calls that are already being serviced by an IVR system. For completeness, note that in addition to calls that are not in the queue, this disclosure relates to calls that happened in the past (call history) as well as calls that are currently happening, in which a caller is speaking with one or more human agents. The latter case may be described as active calls. A visual interface of the system may allow agents to rapidly identify call parameters and caller priorities of inbound calls and calls in progress. The system may also allow tracking the activity levels of distributed agents across multiple locations. This tracking may provide an enterprise with numerous opportunities to adapt their management of operations and human resources, in accordance with the enterprise's strategy and philosophy. An enterprise, for example, may establish incentives for high levels of productivity and effectiveness, as well as using the data to support and train agents whose productivity lags behind the rest of the team. In an embodiment, all agents may have access to much of the same information as management, allowing agents with low productivity to note the higher effectiveness of their coworkers. Embodiments of the system are further described herein below using the figures.

In one aspect, a computer-implemented method for real-time handling of active voice communications is provided. The method can include receiving a plurality of voice communication requests from a plurality of user devices; generating user interface (UI) data comprising communication request information associated with the plurality of voice communication requests; transmitting the UI data to a plurality of agent devices, wherein a UI is presented on each of the plurality of agent devices based on the UI data, the UI comprises a plurality of selectable UI components corresponding to the plurality of voice communication requests, and each UI component includes communication request information associated with a corresponding voice communication request; and initiating a first active voice communication, for a first voice communication request, between a first user device and a first agent device in response to receiving a service request from the first agent device to service the first voice communication request.

In an embodiment, the first agent device sends the service request based on communication request information associated with the first voice communication request.

In an embodiment, the method further comprises prior to initiating the first active voice communication, for the first voice communication request, between the first user device and the first agent device, determining that a first agent associated with the first agent device is available to service any of the plurality of voice communication requests.

In an embodiment, the method further comprises receiving a request from a second agent device associated with a second agent to join the first active voice communication after a first UI component corresponding to the first voice communication request is selected on the second agent device to present content associated with the first active voice communication; and in response to receiving the request from the second agent device to join the first active voice communication, connecting the second agent device to the first active voice communication.

In an embodiment, the communication request information of each UI component is obtained from a customer relation management (CRM) system.

In an embodiment, the communication request information of each UI component includes a user status of a user associated with a user device and at least one of: a phone number of the user device, a state of the corresponding voice communication request, a start time, a duration associated with the corresponding voice communication request, or a name of the user associated with the user device.

In an embodiment, the method further comprises after initiating the first active voice communication, for the first voice communication request, between the first user device and the first agent device, updating a state of the first voice communication request from a first state to a second state, wherein communication request information associated with the first voice communication request comprises the state of the first voice communication request.

In an embodiment, a first UI component corresponding to the first voice communication request is selected to display a summary of content of the first active voice communication.

In an embodiment, the method further comprises tracking and obtaining metrics associated with a plurality of active voice communications that include the first active voice communication; and sending the metrics to the plurality of agent devices, wherein the metrics are displayed on the plurality of agent devices.

In an embodiment, the method further comprises during the first active voice communication, in response to detecting a connection drop between the first user device and the first agent device, periodically attempting to reconnect the first user device with the first agent device, and in response to successfully reconnecting the first user device with the first agent device, generating a voice greeting asking whether a user associated with the first user device wants to resume the first active voice communication, and sending the voice greeting to the first user device, wherein the voice greeting is played at the first user device.

A non-transitory computer readable storage media and a server system are also provided herein.

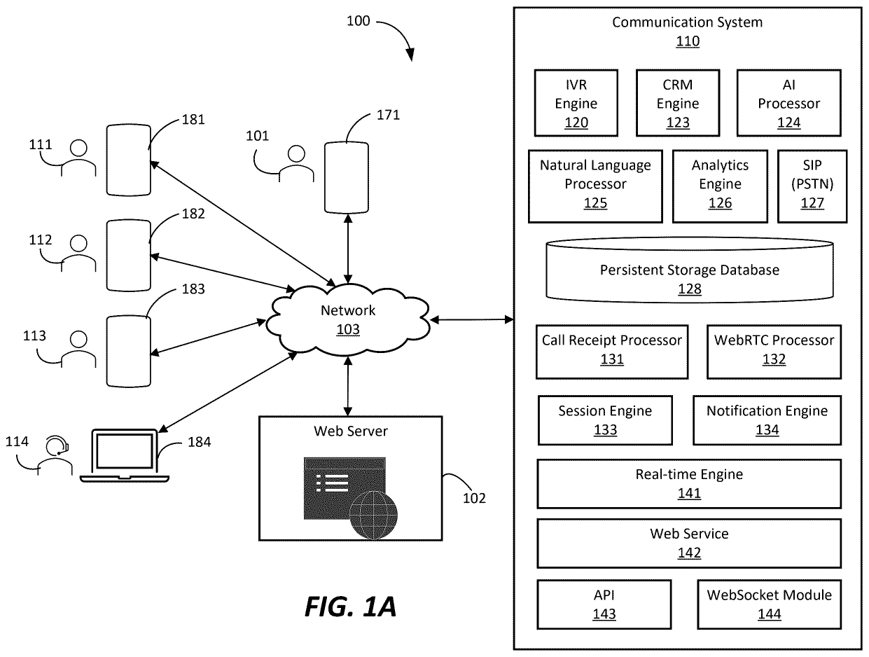

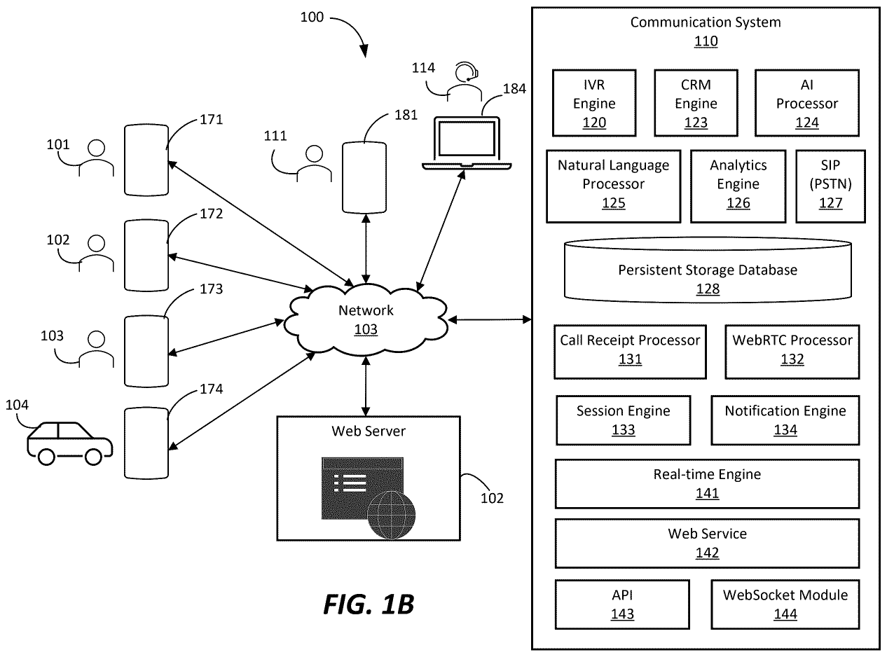

FIGS. 1A-1B are diagrams illustrating an example interactive communication system that enables parallel processing of incoming voice communications according to an embodiment. A block diagram is included in each of FIGS. 1A and 1B. Referring to FIG. 1A, in one embodiment, system 100 includes, but is not limited to, a communication system 110, a user device 171, agent devices 181-184, and a web server 140. User device 171 (and user devices 172-174 of FIG. 1B) and agent devices 181-184 may be a computer system (such as a desktop computer, laptop computer, or server computer system), mobile device (e.g., mobile phone, tablet, smartphone, smartwatch, smart glasses, health (activity) tracker, etc.), gaming system, vehicle infotainment system, or a combination thereof. In an embodiment of system 100, agent devices may be equipped with software (an app) which communicates with modules within communication system 110 by means of network 103. Communication system 110 may also be one or more computing devices, such as one or more server computer systems, desktop computer systems, etc.

The communication system 110, user device 171 (and user devices 172-174 of FIG. 1B), web server 140, and agent devices 181-184 may be coupled to a network 103 and communicate with one another using any of the standard protocols for the exchange of information, including secure communication protocols. As an example, peer-to-peer communication may make use of WebRTC processor 132 or server-mediated communication may be managed by WebSocket module 144. In one embodiment, the communication system 110, user device 171, web server 140, and agent devices 181-184 may run on one Local Area Network (LAN) and may be incorporated into the same physical or logical system, or different physical or logical systems. Alternatively, the communication system 110, user device 171, web server 140, and agent devices 181-184 may reside on different LANs, wide area networks, cellular telephone networks, etc. that may be coupled together via the Internet but separated by firewalls, routers, and/or other network devices. In one embodiment, communication system 110 may reside on a single server, or be distributed among different servers, coupled to other devices via a public network (e.g., the Internet) or a private network (e.g., LAN). It should be noted that various other network configurations can be used including hosted configurations, distributed configurations, centralized configurations, etc.

With continued reference to FIGS. 1A-1B, user 101 may place or initiate a voice communication (e.g., phone call) using their user device 171. Without loss of generality, user 101 can be a customer who wishes to communicate with an enterprise. Voice communications (e.g., phone calls) to the business may be handled by the communication system 110, with the communication from user 101 becoming simultaneously available to available human agents 111, 112, 113 and 114 through their respective agent devices 181, 182, 183 and 184.

In an embodiment, communication system 110 may automatically collect data about the voice communication (or call) and transmit them to agents 111-114, through their agent devices 181-184. If the number is recognized, for example, the system immediately displays a name (individual customer and or affiliation with another business) and current priority ranking. In some embodiments, information such as the reason for the call or the call topic is not available until an inbound call or connection is answered by either an agent or the IVR. Once an agent has answered the call, their name is listed for the benefit of both the customer and other agents at the enterprise. The time and date of the call can be displayed along with the duration of the call and the amount of time, if any, spent by the customer waiting in the queue. The key information may allow the agents 111-114 to use previously established guidelines for determining as to which agent(s) will answer voice communications and dictating the order in which the voice communications may be answered. In one embodiment, communication system 110 may maintain a detailed log of past communications. The log may enable an agent to rapidly identify a past interaction or communication with the user (e.g., user 101) and resume the interaction or communication where they previously left off. In an embodiment, access to information about calls (voice communications) as well as control over an agent's role in any given call is handled by software (an “app” or “application”) installed on each agent's device. That app is not needed on the device used by the caller (user attempting to reach the enterprise).

System 100 may allow for a distributed team of human agents, e.g., an employee or a person associated with a business who is authorized to respond to voice communications. The agents 111-114 can be at a shared location or distributed locations. The agents 111-114 may not need to be in the same physical location, e.g., office, building or even in the same city or country.

In an embodiment, communication system 110 includes, but is not limited to, IVR system 120, CRM system 123, artificial intelligence (AI) processor 124, natural language processor 125, analytics engine 126, and session initiation protocol (SIP) module 127, which handles interactions with the Public Switched Telephone Network (PSTN). In this embodiment, communication system 110 may further include call receipt processor 131, WebRTC processor 132, session engine 133, notification engine 134, real-time engine 141, web service 142, application programming interface (API) 143, and WS (WebSocket) 144. IVR system 120 may process a voice communication (“call”) from user 101, e.g., if for some reason no agents are available to answer the voice communication immediately. When that happens, such users may be described as being in the IVR queue. In this disclosure, it is clear that this IVR queue may be described as a pool or space. Calls in the IVR queue may be described as backlog or real time load. As with any set of entities (users or callers in this case), users in the queue can be described in tabular form, with columns corresponding to variables including but not limited to the time at which the request for a connection was detected, caller phone number, and other values that may be pulled from the CRM by the system. The enterprise can determine how to sort that table for the purpose of determining which call can be answered next: if by connection request timestamp, then the IVR queue may resemble the conventional counterpart. However, all inbound calls are visible to all agents at the enterprise (business) and it is possible for such inbound calls to be answered according to any of the values, including caller priority, with said caller priority further discussed later in this disclosure.

FIG. 1B shows the communication system 110 in a situation, for example, where four users (e.g., callers) 101-104 have placed or initiated voice communications (e.g., phone calls) to a business. In this example, user 104 is calling from the interior of a moving vehicle.

Effective handling of concurrent voice communications may be supported by communication system 110 which, in one embodiment, may combine information obtained about each user (or caller) during the initialization of the connection with any information available about a user identifier associated with the user, for example, a phone number, email address, etc., in CRM system 123. Without loss of generality, the users 101-104 may be assigned priority classifications such as VIP, preferred client, existing client, family member, new phone number and/or spam. These classifications are determined by the business (enterprise) and may include automatic classification, in an embodiment, according to criteria from the CRM such as overall account value, or by manual override. This allows the agent, for example, agent 111, to provide faster service to high priority clientele by pulling out (answering) the incoming voice communications from the line or communication channel based on the priority assigned instead of in the order of the calls received. During a marketing drive, as an example, an agent may be instructed to prioritize new user identifiers (e.g., phone numbers).

As shown in FIG. 1B, two agents 111, 114 are shown as free and available to answer the incoming communications. If both agents have already answered incoming communications from users (e.g., users 101-102) via their respective agent devices 181 and 184 which, in an embodiment, have proprietary software or apps installed on them, and these agents are busy (unavailable), the other two callers 103-104 may be routed to IVR system 120, to be serviced or answered by any agent who becomes available based on the priorities assigned to the users. In an embodiment, IVR system 120 may be an automated voice communication system that uses prerecorded messages to guide users (callers) through a series of options to allow the callers (e.g., users 103-104) to navigate a menu, access information, or route voice communications (e.g., calls) without speaking to a live agent. At this point, the user can be said to be in the IVR queue, which may be a pool or set of users, regardless of the chronological sequence, who are interacting with the IVR. A caller may interact with IVR system 120 by selecting (e.g., touching or pressing) the numbers on the keypad of their user device while, in one embodiment, also viewing in text format on their device the menu being spoken by the IVR recording or voice synthesizer. Users may also choose to reply verbally or speak commands that may be recognized by the speech recognition system or software of the IVR system 120. Based on the input of the caller, IVR system 120 may route the user to an appropriate agent (e.g., agent 111 or 184) when the agent is available. A related but somewhat different transition arises when an agent at the business (enterprise) is scanning visually through calls in the queue and chooses to engage directly with that user.

In an embodiment, web server 102 may be a system that delivers web pages and other content to user devices 171-174 and agent devices 181-184 over the Internet. Web server 102 may be a static web server that delivers pre-existing files or content as they are, or web server 102 may be a dynamic web server that generates content on the fly using databases (not shown) and application logic. It is noted that while FIGS. 1A-1B show the web server 102 as being separate from communication system 110, in some embodiments, web server 102 may be part of communication system 110. In an embodiment, callers (users engaged in voice communications with the enterprise) are not expected to have a proprietary app installed on their devices, but are sent an SMS containing a dynamic link generated by call receipt processor 131 which, in turn, leverages a browser on the caller's smartphone (if available) to provide some of the interactive features mentioned above.

Still referring to FIGS. 1A-1B, persistent storage database 128 may serve to store data from current and past voice communications. Web server 102 may allow communication system 110 to provide information to users (callers or agents) on any user device or agent device with a web connection. CRM system 123 may contain detailed information and history for each caller. In an embodiment, this customers relation management (CRM) system may be integrated into communication system 110 by utilizing data from persistent storage database 128 for CRM purposes that rely on a complete history of each customer's interactions with the enterprise. In that case, the database can be accessed when employees of the enterprise are conducting routine management of customer requests such as follow-up calls, fulfillment of orders, etc. In another embodiment, a third-party CRM selected by the enterprise may interface with system 110. Communication system 110 may retrieve information relevant to an active communication from CRM system 123, and write data to CRM system 123 during or after a voice communication.

In an embodiment, AI processor 124 enables a range of capabilities and interacts with other modules, including natural language processor 125.

In an embodiment, analytics engine 126 may provide rich and actionable information to a business about the team's performance and customer experience. In one embodiment and without limitation, the call analytics engine 126 may track metrics including call velocity (e.g., quantity of calls for a given time period, e.g., hour), agent metrics such as voice communications answered or serviced in a given time period (e.g., per hour), customer metrics such as communication times and durations, and/or wait times if applicable. The analytic engine 126 may also track, for example, interactions between callers and the IVR system. These interactions may include instances in which the caller hangs up or terminates the connection before completing a procedure or action programmed into the IVR. Analysis of such calls may, for example, alert the enterprise to problems with their IVR menu system, including the detailed wording of questions or instructions (the script). Additionally, in an embodiment, analytics engine 126 may include components allowing voice analytics for purposes such as recognizing a particular caller or conducting sentiment analysis.

In an embodiment, SIP module 127 may be a telephony bridge portion of the backend of communication system 110. For example, SIP module 127 may operate a signaling protocol to establish, manage, and terminate multimedia session, such as voice communications over network 103. In other words, SIP module 127 may be responsible for the “handshake” process that sets up, manages, and ends the communication sessions between communication system 110, and user devices 171-174 and agent devices 181-184. In an embodiment, communication system 110 may make use of third-party services currently available from multiple vendors for the purposes of establishing and managing audio communication over the PSTN. Such vendors allow meetings which, at the very least, can bridge PSTN calls with online meetings that additionally include participation from VoIP platforms as well as, potentially, video streaming, text messaging, screen sharing and more. In an embodiment, rather than use a two-way audio call as the fundamental building block for all voice communications, a meeting function may be invoked instead. This leads to ensuring that each call has the “permeability” mentioned previously. Each call in which an agent is speaking with a customer is an instance of a “meeting” in which numerous individuals can potentially participate. This allows other agents (or customers) to “join” the call: they are actually (from the system perspective) joining a meeting. Other components of communication system 110 such as WebRTC processor 132 (with RTC signifying real-time communication) and WebSocket module 144 allow further enhancement of the call with web-based communication such as, for example, text-based chatting with an agent or the communication, verbal or text based, with the IVR or an AI agent filling the role of IVR. In an embodiment, WebRTC processor 132 may provide streaming of audio or even video, while WebSocket module 144 may enable two-way communication between apps on enterprise agent devices and real-time module 141. In an embodiment, agents interact with communication system 110 by means of a mobile app, while customers who wish to go beyond voice-only communication may do so by means of a browser on their mobile device.

It is noted that while system 100 shows four user devices 171-174 associated with users (callers) 101-104 and four agent devices 181-184 associated with agents 111-114, embodiments of the application are not limited to this example. In other words, any number of user devices, agent devices, users, and agents may be part of system 100.

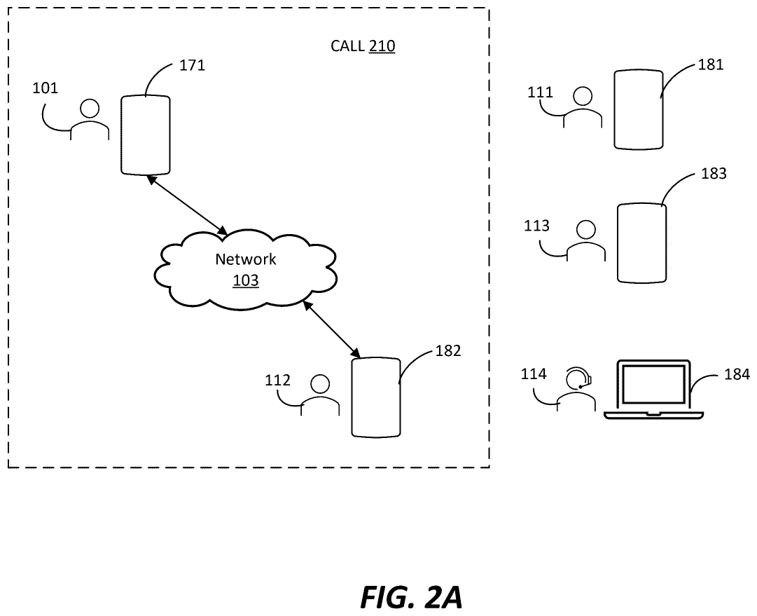

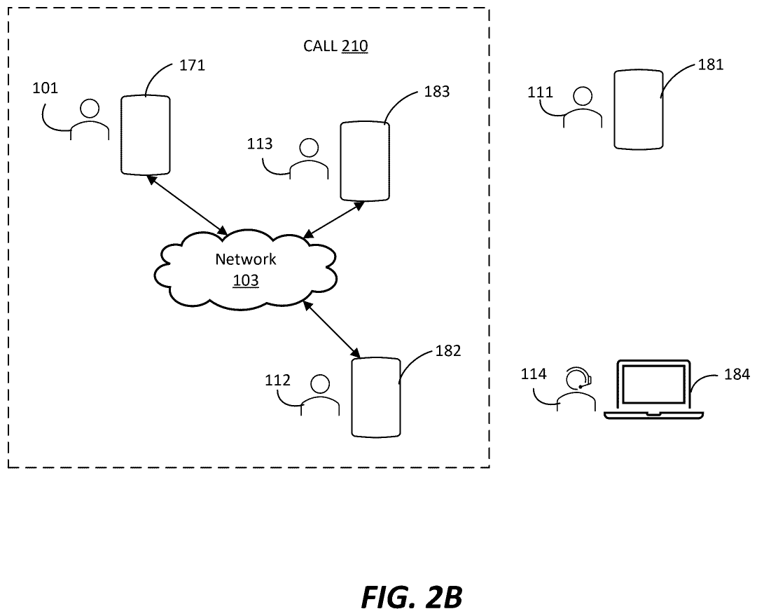

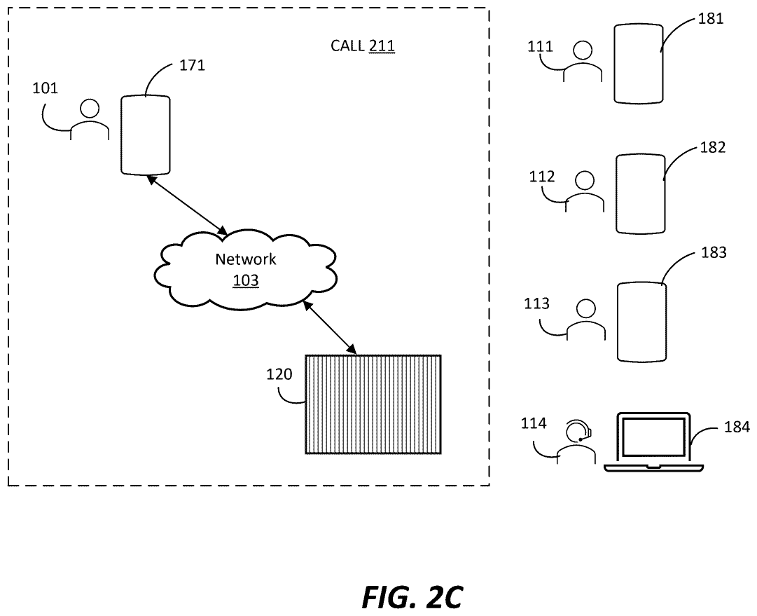

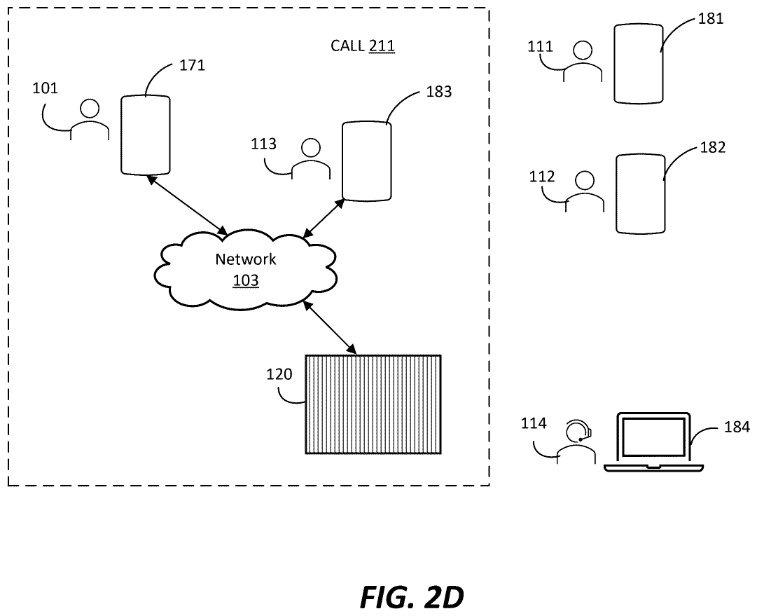

FIGS. 2A-2D are diagrams illustrating examples of different active voice communication scenarios according to an embodiment. In FIGS. 2A-2D, the transparency of active voice communications (e.g., calls) and permeable boundaries for a voice communication (also referred to as open-door feature) are shown. Referring to FIG. 2A, active call 210 is in progress between user 101, who is using their user device 171, and agent 112, who has chosen to answer the call 210 using their agent device 182. During the call 210, agents 111-114 can visualize each other's activities. In particular, available agents 111, 113 and 114 may be notified of the status of call 210 and can view detailed information about the call including but not limited to the identity of the caller and any records about them in the CRM, call parameters including start time and any wait time, if applicable, prior to being answered, as well as a computer-generated transcript of what has been and is being said (voice-to-text or speech-to-text). One or more of available agents 111, 113 and 114 may be able to join the active call 210 at any time due to the open-door feature and transparent nature of the permeable call boundaries, which as mentioned above, is implemented in one embodiment by using online meetings (bridged, in many cases, to PSTN participants-the customers) instead of two-way audio calls as the fundamental building blocks for all calls. The benefit to users (callers) is that unlike a conventional PABX environment, where voice communications (e.g., calls) are often dropped during a transfer and where extended hold times arise while awaiting the correct business representative, agents 111-114 can provide a smooth handoff of calls instead of performing a call transfer or placing a caller on hold. Furthermore, an alternate agent can intervene, pulling callers from an ongoing interaction with the IVR within the IVR queue rather than requiring long holds.

In FIG. 2B, agent 113 has used their agent device 183 to join the call 210. As mentioned above, this is possible in one embodiment because every call begins as a meeting which has capacity for a plurality of participants. This stands in contrast with prior art systems in which each call is initially simple two-way voice communication. Agent 113 may be a business owner, who has a relationship with user 101 and wishes to greet them and check on a transaction. The transaction can be any transaction related to a business such as a purchase transaction, customer support transaction, inquiry about a product, inquiry about an account, etc. Alternatively, agent 113, for example, may also be an employee whose expertise and role at the business is such that they are the best choice of agent for completing the transaction with the user 101. In that case, a warm handoff is enabled by the presence of both agents 112-113 on the call 210 at the same time. That is, agent 112 may introduce user 101 to agent 113 before allowing agent 113 to assume the lead role in the conversation. In some cases, agent 112 may not leave the call 210 until agent 112 is certain that the transition to agent device 183 of agent 113 has gone smoothly and that agent 113 is clearly on track to solve the caller's problem.

In the event that no agents answered the call from user 101, the IVR system 120 may engage with user 101 to initiate automated interaction 211, as shown in FIG. 2C. At this time, the caller is said to enter the IVR queue, which as mentioned above is different from conventional queues in that chronological sequence alone does not determine which caller may speak to an agent first. As with active call 210 between agents 112-113 and user 101, automated interaction 211 is transparent and permeable. At any time, one or more of agents 111-114 may join the call, as shown in FIG. 2D. This is possible, in an embodiment, because every voice communication established by SIP/PSTN module 127 is a meeting supporting a plurality of participants. For instance, in FIG. 2D, agent 113, using agent device 183, may join the call 211 with user 101. The agent 113 may note the achievement during the user's interaction with IVR system 120, and service or pick up the call smoothly from the IVR system 120 and proceed with the transaction.

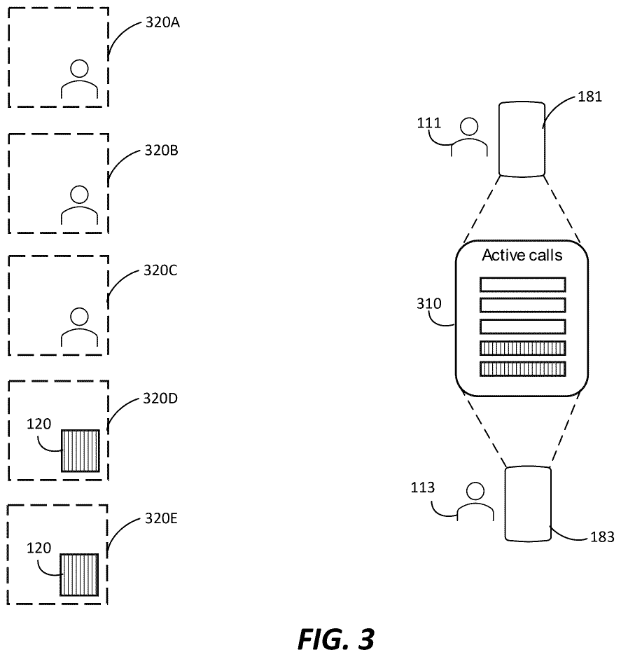

FIG. 3 is a diagram illustrating the management of multiple voice communications according to an embodiment. The dashed boxes on the left each represent an inbound call from a customer, in which the dashed boxes remind us that, as disclosed by means of FIGS. 2A-2D, each call is permeable and transparent, meaning that other agents can view or listen to what is taking place in each call and, potentially, join or connect to the call in a manner similar to joining an conference call or online video meeting. The icons within boxes 320A, 320B and 320C represent live agents, while the box in 320D and 320D indicate that the call is being serviced by IVR. The management of the voice communications, in an embodiment, may be performed by communication system 110 of FIGS. 1A-1B. Available agents 111 and 113 may have access to each of the voice communications 320A-E. For example, a call user interface UI 310 may be displayed on agent devices 181 and 183, where the calls UI 310 may include visual representations of the voice communications 320A-E. Using the UI 310, agents 111 and 113 may select the specific voice communication to handle when the agents are available.

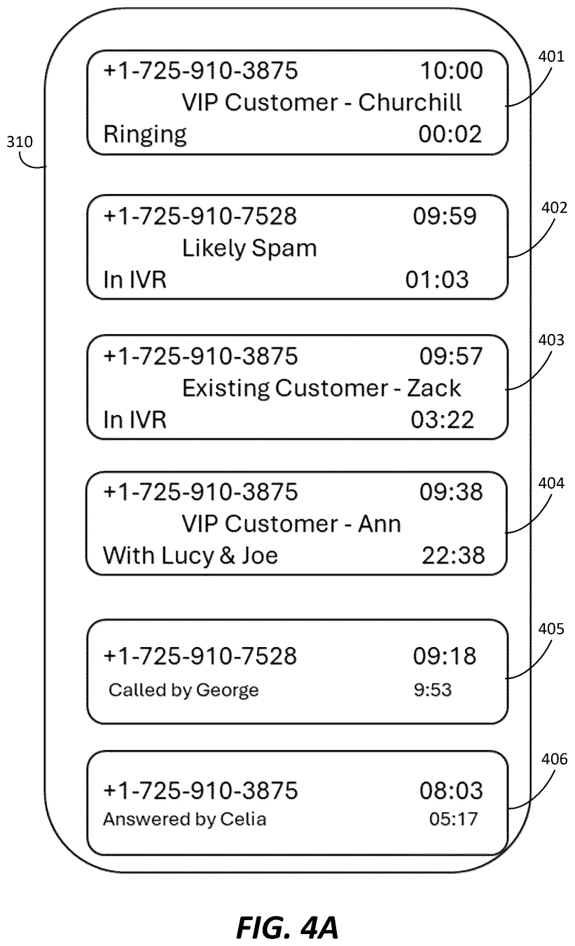

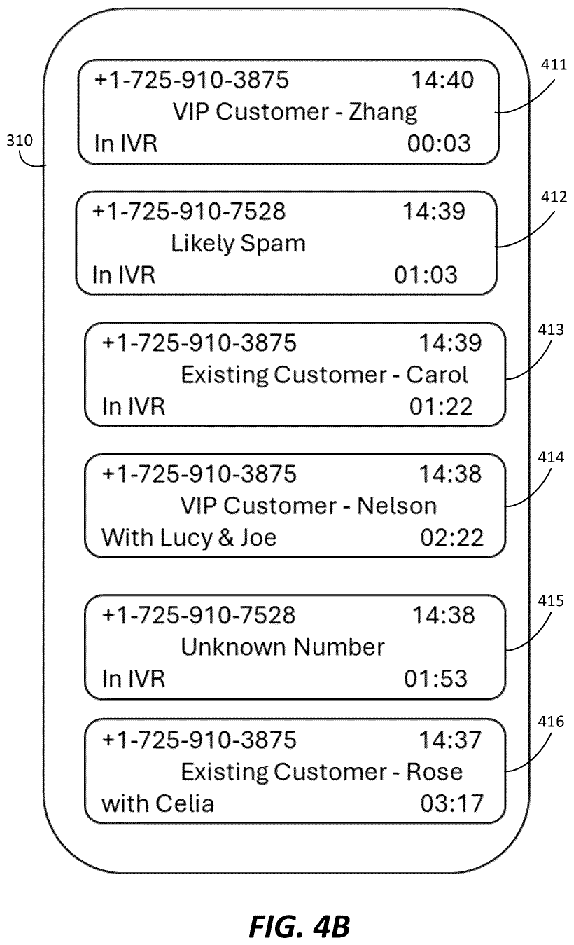

FIGS. 4A and 4B represent screenshots of a mobile device on which an agent is viewing a set of voice communications, according to one embodiment. The frames in FIGS. 4A and 4B may be viewed as a more detailed illustration of UI 310. Each call is represented by one of the boxes labeled 401 through 412. In this illustration, we see calls that are “active” (currently taking place) as well as two that have already ended (405 and 406) and are described as being in the call history. In the current example, each call is listed with either four or five data field values, which may be referred to as communication request information. In some cases, the number of the customer or caller is shown in the upper left of the box, with the state of the call in the lower left. The states illustrated here include “ringing” for call 401 which has not yet been answered; in IVR for calls being serviced by IVR Engine 120; “Called by George” for completed call 405 indicating it is in the past; “With Lucy and Joe” indicating a caller is being assisted by two agents or enterprise-based users; and “With Celia” for call 412 in which a single agent is assisting a caller. The data in the top and bottom corners of each box, in this embodiment, indicate the start time and duration of each call. Ongoing calls have a fifth data field display in the center of the box, identifying the caller and indicating, where known, the priority ranking of the caller. In this example, a choice has been made (e.g., in a user-dependent or enterprise dependent manner) to omit the fifth data field with caller priority classification. It will be clear to a person skilled in the art that calls may be represented in alternate form, with a different selection of relevant data indicated. FIG. 4A is a diagram illustrating example visual representations of voice communications displayed on an agent device according to an embodiment. As shown, the active calls UI 310 may include, but not be limited to, visual representations (or UI components) 401-406 of current and recent active voice communications (e.g., calls). Active calls UI 310 may be displayed on an agent device (e.g., device 181 or 183 of FIG. 3). In each of visual representations 401-406, key data is shown for each communication, allowing available agents to make decisions about answering and/or directly joining the communication. This is yet another aspect of the transparency of communication enabled by the embodiments of the application, along with the use of other visualization tools to allow rapid decision-making. In an embodiment, one or more of the available agents may join the communication at any moment in time while the communication is active without requiring approval from a host of the communication (e.g., caller or agent). In FIG. 4A, the most recent call 401 is shown at the top of the screen and has not yet been answered. In an embodiment, each enterprise may configure the duration of the time interval during which the call is shown as “ringing”, while the caller waits and agents have a chance to answer the call before it is routed to the IVR system. Call 401 has been identified by real-time engine 141, by referencing CRM Engine 123, as being a VIP customer. In an embodiment, the system may be configured to alert available agents when a call such as this is detected for immediate answering. Calls 402, 403 and 404 are ongoing, and the real-time engine 141, again querying CRM Engine 123, identified 403 as “Existing Customer Zack” and 404 as “VIP Customer Ann”. Note that call 402 has been identified as likely spam. UI 310 further shows that calls 402 and 403 are both being serviced by IVR Engine 120. In contrast, VIP Customer Ann is listed as having two agents speaking with her: Lucy and Joe. Without loss of generality, Lucy and Joe can be identified as an agent and her manager. Calls 405 and 406 are no longer current (active). They have ended and are part of the call history, which may be identified with components having a different indication (e.g., color) than the active or current calls.

FIG. 4B further illustrates information displayed by UI 310 on agent devices, focusing on calls that are being serviced either by human agents or by IVR Engine 120. In the example UI 310 shown in FIG. 4B, visual representation (or UI component) 411 may identify a first communication that may be selected by the next available agent from the IVR system because caller Zhang has been identified as a VIP customer and has the highest priority of all communications in the IVR queue. Box 412 also shows a call that is in the IVR queue, but which has been flagged as Likely Spam. Box 413 shows that “Existing Customer Carol” is also engaged with the IVR queue. The call identified by box 414 has been answered by Lucy, who noted the VIP Customer status. Joe may be operating an agent device and may also elect to join voice communication 414. Note that Joe may join communication 414 at any given point in time while communication 414 is active without requiring approval from Lucy or the caller (Nelson in this example). Call 415 from an unknown number is in the IVR queue. The last call listed on the screen, 416, has been identified as an Existing Customer named Rose and has been answered by enterprise agent Celia. Therefore, in the examples illustrated in FIGS. 4A-4B, calls from important customers (e.g., VIP customers) can be serviced in a short amount of time without having to wait for a lengthy time period in the IVR queue. In some embodiments, UI components 401-406 and 411-416 may be selectable (e.g., click or tap on) to reveal or display additional information associated with their corresponding voice communications (calls). For example, when an agent selects a UI component (e.g., UI component 414), a summary of the content of the voice communication associated with the UI component may be displayed (e.g., summary of the conversation or communication between Nelson and Lucy). By viewing the summary, Joe, for example, may determine that the communication is highly important, and thus, he may decide to join the active communication between Nelson and Lucy. In some embodiments, the summary may be generated using voice-to-text transcription, which may be part of analytics engine 126 (previously described).

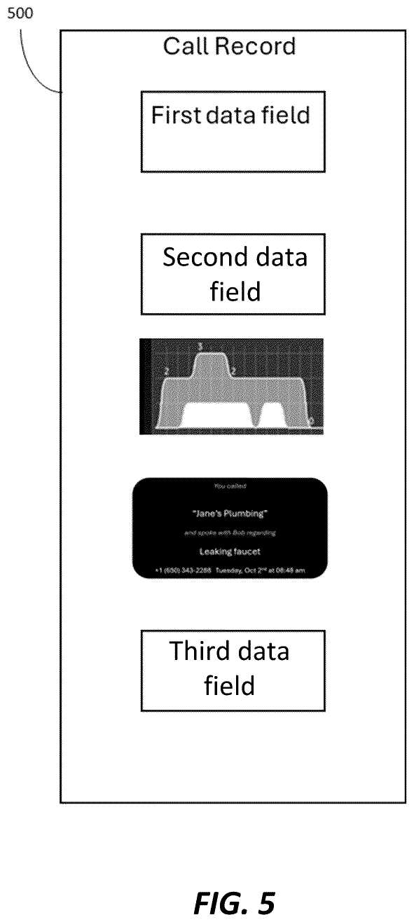

FIG. 5 is a diagram illustrating an example voice communication record according to an embodiment. In FIG. 5, voice communication (or call) record 500 may be generated during a voice communication, and held in a low-latency memory cache for the duration of the call. In an embodiment, the record may be transferred to persistent storage database after the communication ends. Record 500 may include multiple data fields or objects. Without limitation, data to be collected and stored in the record 500 may include start and end times, user priority rank, a reference to relevant records in a CRM system (e.g., CRM system 123), one or more user identifiers of one or more agents (e.g., names, employees IDs, etc.) who answered or joined the communication, visual representations or images of charts tracking key variables during the communication, visual representations or images containing next and perhaps a business logo, audio or video files, AI-generated transcription of voice communications, etc. This record 500, and visual representations 401-406 of FIG. 4, can be accessed by any agent during the communication to assist the agent in deciding whether further support is needed. The record 500 may also be accessed by agents or by the user (caller) after the transaction has been completed. Selected fields may allow editing by agents and/or users.

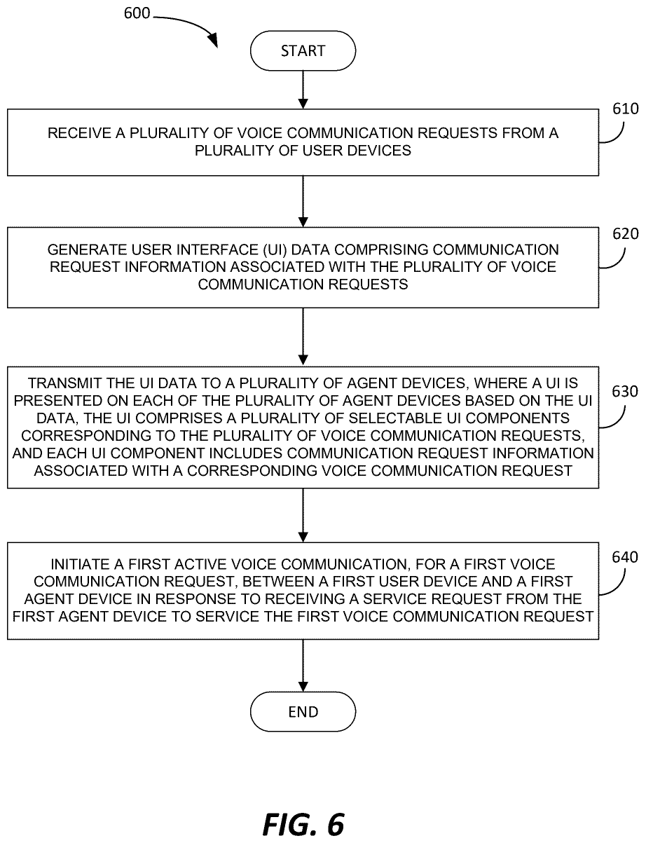

FIG. 6 is a flow diagram illustrating a process of processing voice communications according to an embodiment. Method 600 may be performed by processing logic that may comprise hardware (circuitry, dedicated logic, etc.), software (such as is run on a general purpose computer system or a dedicated machine), firmware, or a combination. In one embodiment, the method 600 is performed by communication system 110 of FIGS. 1A-1B.

Referring to FIG. 6, at block 610, the processing logic may receive a plurality of voice communication requests (e.g., calls) from a plurality of user devices (e.g., user devices 171-174). At block 620, the processing logic may generate UI data comprising communication request information associated with the plurality of voice communication requests. For example, the UI data may include phone numbers of the user devices, states of the voice communication requests, start times, durations associated with the voice communication requests, names of users associated with the user devices, and/or user statuses of the users. In some embodiments, the UI data may be formatted in a text-based format for representing structured data, such as JavaScript Object Notation (JSON) format. At block 630, the processing logic may transmit the UI data to a plurality of agent devices, where a UI is presented or rendered on each of the plurality of agent devices based on the UI data. The UI may comprise a plurality of selectable UI components corresponding to the plurality of voice communication requests (e.g., UI components 401-406, 411-416), and each UI component may include communication request information associated with a corresponding voice communication request (e.g., a phone number of a user device, a state of the corresponding voice communication request, a start time, a duration associated with the corresponding voice communication request, a name of a user associated with the user device, and/or a user status of the user). At block 640, the processing logic may initiate a first active voice communication, for a first voice communication request, between a first user device and a first agent device in response to receiving a service request from the first agent device to service the first voice communication request. For example, when a first agent associated with the first agent device is available to service or answer the plurality of voice communication requests, the first agent may use the first agent device to notify communication system 110 that the first agent is available. This action by the first agent may trigger the first agent device to send the service request to communication system 110 to initiate the first active voice communication between the first user device and the first agent device.

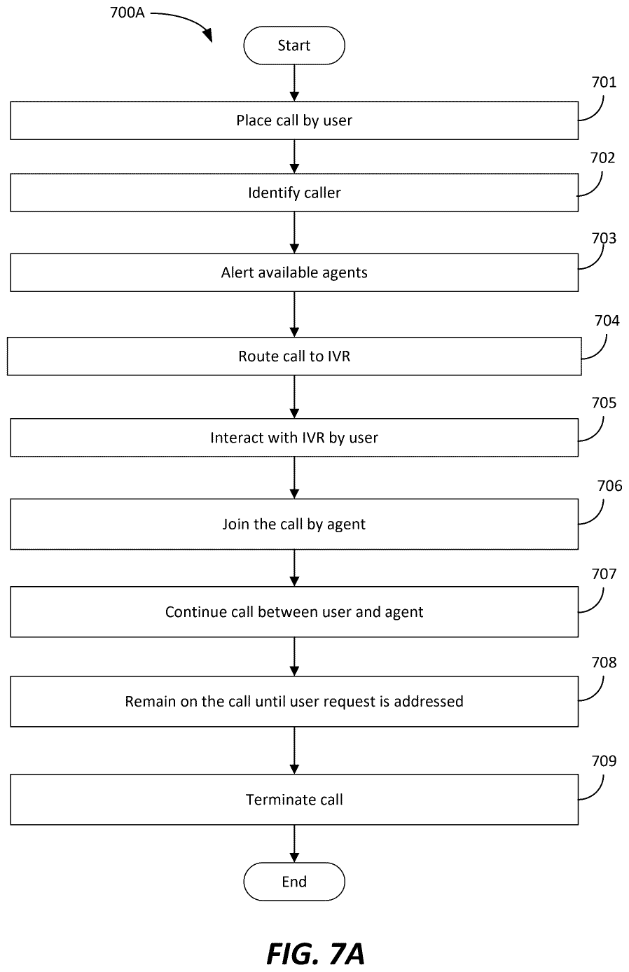

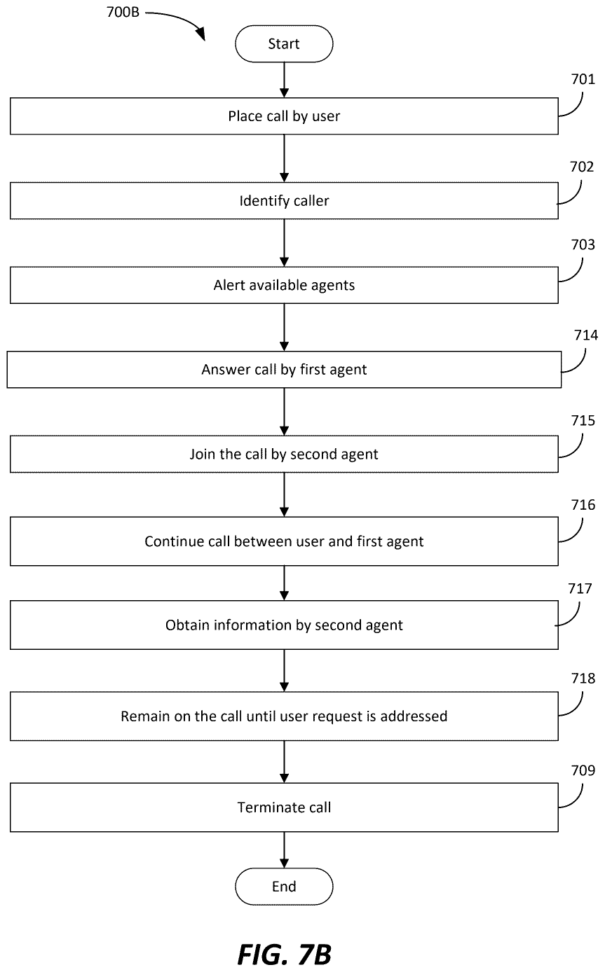

FIGS. 7A-7B are flow diagrams illustrating two different timelines out of countless possible sequences in which a call enabled by communication system 110 may take place according to an embodiment. Methods 700A-B may be performed by processing logic that may comprise hardware (circuitry, dedicated logic, etc.), software (such as is run on a general purpose computer system or a dedicated machine), firmware, or a combination. In one embodiment, the methods 700A-B are performed by system 100 of FIGS. 1A-1B.

In FIG. 7A, a possible timeline is explored, with the following discussion illustrating how this might take place in an embodiment. At block 701, a user such as a customer may place a call to an enterprise. Block 702 is where the call is detected by SIP/PSTN module 127, which relays all available information such as the phone number for the caller and caller ID to the real-time engine 141. At block 702, and to identify the call, real-time engine 141 uses call data from SIP/PSTN 127 to consult CRM Engine 123 which in turn has access to (or in some embodiments, is identical to) persistent storage database 128. The combined result is a data set that includes, in one embodiment, the call start time, phone number for inbound call, caller ID, and data from CRM 141 such as customer priority level. That data set is used to initialize Call Record 500. At block 703, agents are alerted about the call by means that include at least providing them with data record 500 as summarized in graphical user interface (GUI) 310 in a manner similar to what is indicated in call indicator 401 (FIG. 4A), where the call status is “ringing”. In one embodiment, and subject to configuration choices by the enterprise, alerting the agents may include audible and/or haptic signals. Agents or managers from the enterprise may select (e.g., click or tap on) a call indicator to immediately see the above information along with other data provided by CRM 141, such as recent interactions between the customer and the enterprise. At block 704, after a pre-determined time interval, the unanswered call is routed to IVR Engine 120, and the call indicator displayed to agents is updated to reflect that the call is now in IVR (e.g., call indicators 402-403). At block 705, the caller can immediately begin interacting with the IVR by responding to verbal prompts using their keypad or spoken answers. In the meantime, CRE 141 further determines that the caller is known by querying persistent storage database 128. Having determined that the caller is using a recognized smartphone, call receipt processor 131 generates an SMS containing a link that is sent to the caller. Said caller may use that link to initiate text-based interaction with the IVR in addition to the audio communication. As the caller continues to interact with IVR, the resulting data is added to call record 500. That data is displayed to an agent who selects the call using their app. At block 706, the agent, viewing the data in call record 500, chooses to join the call. In an embodiment, communication system 110 allows the agent to join the call as follows. Real-time engine 141 may send a request for a meeting to a third-party service provider. Once the online meeting has been created and the corresponding access tokens received, real-time engine 141 may place the agent and the caller in that meeting. At block 707 shows the call continuing, now in the form of a two-person meeting supported, in an embodiment, by WebRTC Processor 132, WebSocket module 144, real-time engine 141 and the contracted third-party meeting service. At block 708, the agent communicates further with the caller until the reason for the call has been entirely resolved. Block 709 is triggered when SIP/PSTN module 127 detects that either the agent or the caller has selected an end-call action, triggering call tear-down and allowing the agent to end the call, possibly after further notes are added to call record 500.

A second possible timeline is described in FIG. 7B, where the call is first answered by an agent and the caller never interacts with the IVR. Blocks 701, 702 and 703 for this timeline (FIG. 7B) are identical to the previous example (FIG. 7A). In this timeline, block 714 indicates that an agent answers the call before it goes to IVR. When the agent answers the call, communication system 110 proceeds in a manner closely related to what was described at block 706 for the previous example timeline. In this case, the agent carries out an “answer call” action (such as clicking on a button on the screen of their device), That action triggers a sequence of events involving real-time engine 141, which requests creation of a meeting from the contracted cloud computing platform, with the ultimate result that the agent and, via SIP/PSTN module 127, the caller are placed in a meeting which functions initially as a two-way voice-call. In an embodiment, real-time engine 141 obtains information from newly established call record 500 or from persistent storage database 128 to determine that the caller has a smartphone and to send an SMS to the caller containing a link generated by call receipt processer 131. The caller may choose to use that link to enhance their communication experience with the enterprise agent. At block 715, a second agent has benefited from the “transparent” nature of the call, viewing call record 500 and electing to join the call. This last block is possible because the underlying entity through which the customer and first agent are communicating is a meeting. This illustrates what has been described as the “permeability” of the call. Although this example does not specify the reason why the second agent joined the call, possibilities include having been alerted by the first agent or by real-time engine 141 which may have leveraged call record 500 to determine that the second agent is likely to be the best qualified to assist the customer. Block 716 in this example has the first agent continue assisting the customer while, in real time, the second agent (block 717) obtains further information needed to address the customer's need. Once the information is obtained, block 718 shows that in this example both agents remain on the call until there is a consensus that the matter has been suitably resolved. Block 709 once again involves SIP/PSTN module 127, which detects a change in the call state triggered when the caller (for example) selects “end call” on their device. Block 709 may include additional record-keeping or other actions taken by one or both of the agents. Prior to ending the voice communication, call record 500, with updates and further information such as voice transcripts and agent notes, all accumulated during the voice communication, is added back to PSD 128. Both FIGS. 7A and 7B show that at each stage of the call, further data is collected and stored that is accessible via the call record. It is clear to a person of ordinary skill in the art that this is readily transposed to communication relying on text-based chat tools, email, etc.

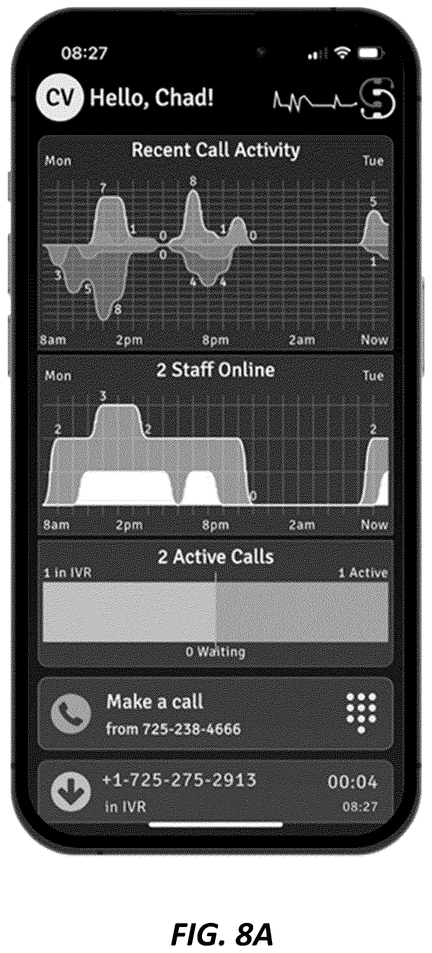

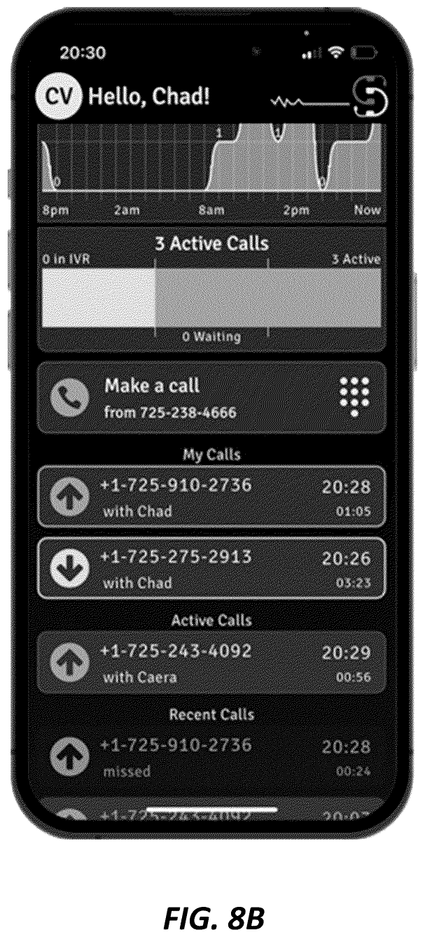

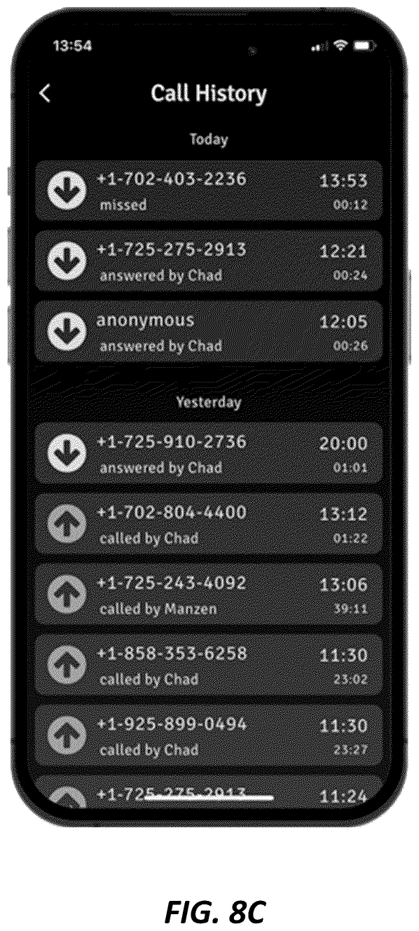

FIGS. 8A-8C are diagrams illustrating example information associated with voice communications displayed on an agent device according to an embodiment. In FIGS. 8A, 8B and 8C, information displayed on an agent device (e.g., mobile phone, tablet, laptop computer, desktop computer, etc.) may be in both graphical and text format. The availability of this data to agents allows the parallel processing of inbound voice communications in a transparent manner, as well as allowing communication system 110 to collect information to be processed by call analytics engine 126 for subsequent evaluation by management. Graphics and charts (of metrics such as call velocities) allow agents, and in particular managers or small business owners to instantly assess aspects of business operations. In an embodiment, FIG. 8A shows the home screen or landing screen presented to a business owner or agent at an enterprise that may utilize communication services within the corresponding app. FIGS. 8B and 8C illustrate what might be seen as they scroll down to view content below what is shown in FIG. 8A. At the top of FIG. 8A, a Call Velocity chart displays the quantity of calls per hour for the most recent 24 hour period. The data above the horizontal line represents inbound calls in this particular embodiment, with missed inbound calls shown in the second shade of gray closer to the horizontal axis. The data below the horizontal axis represents outbound calls, once again including missed (or unanswered) calls in the second shade of gray closer to the axis. The next chart, labeled “2 Staff online”, also covers the most recent 24 hour period and shows how many agents have been logged on and available to receive or place calls. The horizontal gray-scale bar (rendered in color on this particular embodiment of the app, as with prior charts) provides immediate and rapidly interpreted answer to the question “how many calls are taking place right now?”. Below these charts, and continuing in frames 8B and 8C, there are lists (which in an embodiment can be configured by a user to group calls and list them in varying sequence) of current calls in which the user of this particular device is participating. Calls that have ended in the past are also shown. For each call shown, and in a particular embodiment, a user who taps on an entry may be shown a detailed screen with information about the call including participants and voice transcript. If that call is still ongoing (an active call) the user can choose to join the call (a process effected by the back end by leveraging the meeting-like nature of each and every “session” or “call”). A user can also, while on another call, access the details for a second call to which they can send a message (text) without actually joining the call.

The nature of the embodiments disclosed herein intrinsically implies access to information that is being gathered in a nearly instantaneous manner across potentially distant physical locations (for today's often distributed teams of employees, associates and customers). The rate at which this information may be gathered and the level of analytics generated in real-time are key elements in the solution provided herein. The manner in which said information is processed and presented, along with the properties of the communication system, allow immediate corrective action to be taken if a call is not going well or if the data reveals that a customer is not obtaining the desired result or information.

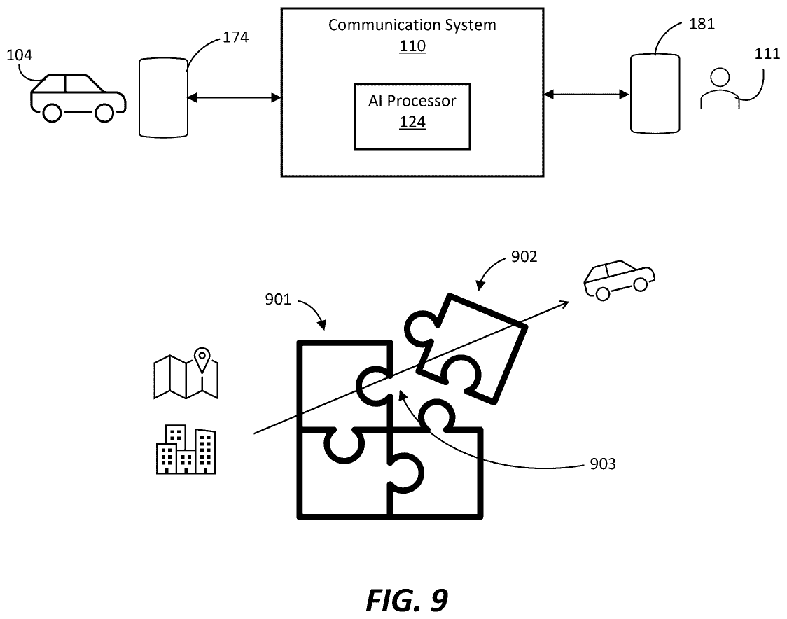

FIG. 9 is a diagram illustrating the handling of dropped voice communications according to an embodiment. In FIG. 9, dropped voice communications (calls) may be reconnected as soon as reconnection capability is available. In this instance, user 104 is in a moving vehicle that passes through a dead zone 903 between a first area 901 and a second non-contiguous area 902 where reception is good. In an embodiment and by way of example only, SIP 127 detects the dropped connection. Call data remains in a cache within real-time engine 141 for a time interval that is enterprise-dependent. Real-time engine 141, by means of SIP/PSTN module 127, periodically attempts to reconnect with the caller by invoking the required outbound call functions, for a time interval and at a frequency that are once again enterprise dependent, that is, configured or determined by each enterprise adopting the disclosed technology. AI processor 124 and natural language processor 125 may use said call data to generate a synthesized greeting, e.g., voice or text greeting, that may be presented to the customer when and if repeated attempts at calling back eventually succeed: “You were just talking to Joe at Joe's Tires. If you'd like to continue that call, please say “YES”. AI Processor 124 may also generate a call summary for reference by the agent if and when the connection is re-established. Clearly the algorithm, flexible in its design, allows for call-back to automatically take place in other circumstances including cases where the communication is dropped for reasons other than physical entry into a cell dead zone, such as an accidental termination of the connection by the caller.

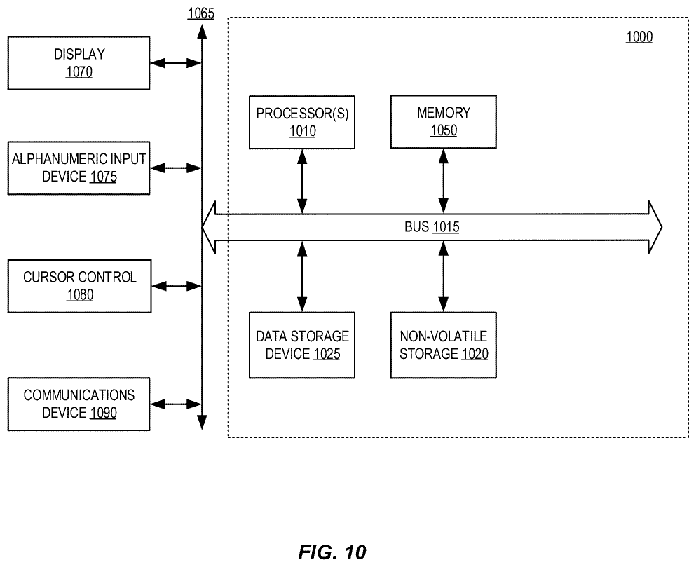

FIG. 10 is an embodiment of a computer system that may be used to support the systems and operations discussed herein. The data processing system illustrated in FIG. 10 includes a bus or other internal communication means 1015 for communicating information, and one or more processors 1010 coupled to the bus 1015 for processing information. The system further comprises a random access memory (RAM) or other volatile storage device 1050 (referred to as memory), coupled to bus 1015 for storing information and instructions to be executed by processor(s) 1010. Main memory 1050 also may be used for storing temporary variables or other intermediate information during execution of instructions by processor(s) 1010. The system also comprises a read only memory (ROM) and/or static storage device 1020 coupled to bus 1015 for storing static information and instructions for processor(s) 1010, and a data storage device 1025 such as a magnetic disk or optical disk and its corresponding disk drive. Data storage device 1025 is coupled to bus 1015 for storing information and instructions.

The system may further be coupled to a display device 1070, such as a light emitting diode (LED) display or a liquid crystal display (LCD) coupled to bus 1015 through bus 1065 for displaying information to a computer user. An alphanumeric input device 1075, including alphanumeric and other keys, may also be coupled to bus 1015 through bus 1065 for communicating information and command selections to processor(s) 1010. An additional user input device is cursor control device 1080, such as a touchpad, mouse, a trackball, stylus, or cursor direction keys coupled to bus 1015 through bus 1065 for communicating direction information and command selections to processor(s) 1010, and for controlling cursor movement on display device 1070.

Another device, which may optionally be coupled to computer system 1000, is a communication device 1090 for accessing other nodes of a distributed system via a network. The communication device 1090 may include any of a number of commercially available networking peripheral devices such as those used for coupling to an Ethernet, token ring, Internet, or wide area network. The communication device 1090 may further be a null-modem connection, or any other mechanism that provides connectivity between the computer system 1000 and the outside world. Note that any or all of the components of this system illustrated in FIG. 10 and associated hardware may be used in various embodiments as discussed herein.

It will be appreciated by those of ordinary skill in the art that any configuration of the system may be used for various purposes according to the particular implementation. The control logic or software implementing the described embodiments can be stored in main memory 1050, mass storage device 1025, or other storage medium locally or remotely accessible to processor 1010.

It will be apparent to those of ordinary skill in the art that the system, method, and process described herein can be implemented as software stored in main memory 1050 or read-only memory 1020 and executed by processor(s) 1010. This control logic or software may also be resident on an article of manufacture comprising a computer readable medium having computer readable program code embodied therein and being readable by the mass storage device 1025 and for causing the processor(s) 1010 to operate in accordance with the methods and teachings herein.

The embodiments discussed herein may also be embodied in a handheld or portable device containing a subset of the computer hardware components described above. For example, the handheld device may be configured to contain only the bus 1015, the processor(s) 1010, and memory 1050 and/or 1025. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of embodiments for such a device would be apparent to one of ordinary skill in the art given the disclosure as provided herein.

The embodiments discussed herein may also be embodied in a special purpose appliance including a subset of the computer hardware components described above. For example, the appliance may include processor(s) 1010, a data storage device 1025, a bus 1015, and memory 1050, and only rudimentary communications mechanisms, such as a small touch-screen that permits the user to communicate in a basic manner with the device. In general, the more special-purpose the device is, the fewer of the elements need be present for the device to function.

It is to be understood that the above description is intended to be illustrative, and not restrictive. Many other embodiments will be apparent to those of skill in the art upon reading and understanding the above description. The scope should, therefore, be determined with reference to the appended claims, along with the full scope of equivalents to which such claims are entitled.

The foregoing description, for purpose of explanation, has been described with reference to specific embodiments. However, the illustrative discussions above are not intended to be exhaustive or to limit the described embodiments to the precise forms disclosed. Many modifications and variations are possible in view of the above teachings. The embodiments were chosen and described in order to best explain the principles and practical applications of the various embodiments, to thereby enable others skilled in the art to best utilize the various embodiments with various modifications as may be suited to the particular use contemplated.

What is claimed is:

1. A computer-implemented method for real-time handling of active voice communications, the method comprising:
receiving a plurality of voice communication requests from a plurality of user devices;
generating user interface (UI) data comprising communication request information associated with the plurality of voice communication requests;
transmitting the UI data to a plurality of agent devices, wherein a UI is presented on each of the plurality of agent devices based on the UI data, the UI comprises a plurality of selectable UI components corresponding to the plurality of voice communication requests, and each UI component includes communication request information associated with a corresponding voice communication request; and
initiating a first active voice communication, for a first voice communication request, between a first user device and a first agent device in response to receiving a service request from the first agent device to service the first voice communication request.

2. The method of claim 1, wherein the first agent device sends the service request based on communication request information associated with the first voice communication request.

3. The method of claim 1, further comprising: prior to initiating the first active voice communication, for the first voice communication request, between the first user device and the first agent device, determining that a first agent associated with the first agent device is available to service any of the plurality of voice communication requests.

4. The method of claim 3, further comprising:
receiving a request from a second agent device associated with a second agent to join the first active voice communication after a first UI component corresponding to the first voice communication request is selected on the second agent device to present content associated with the first active voice communication; and
in response to receiving the request from the second agent device to join the first active voice communication, connecting the second agent device to the first active voice communication.

5. The method of claim 1, wherein the communication request information of each UI component is obtained from a customer relation management (CRM) system.

6. The method of claim 5, wherein the communication request information of each UI component includes a user status of a user associated with a user device and at least one of: a phone number of the user device, a state of the corresponding voice communication request, a start time, a duration associated with the corresponding voice communication request, or a name of the user associated with the user device.

7. The method of claim 1, further comprising: after initiating the first active voice communication, for the first voice communication request, between the first user device and the first agent device, updating a state of the first voice communication request from a first state to a second state, wherein communication request information associated with the first voice communication request comprises the state of the first voice communication request.

8. The method of claim 1, wherein a first UI component corresponding to the first voice communication request is selected to display a summary of content of the first active voice communication.

9. The method of claim 1, further comprising:
tracking and obtaining metrics associated with a plurality of active voice communications that include the first active voice communication; and
sending the metrics to the plurality of agent devices, wherein the metrics are displayed on the plurality of agent devices.

10. The method of claim 1, further comprising: during the first active voice communication, in response to detecting a connection drop between the first user device and the first agent device,
periodically attempting to reconnect the first user device with the first agent device, and
in response to successfully reconnecting the first user device with the first agent device, generating a voice greeting asking whether a user associated with the first user device wants to resume the first active voice communication, and sending the voice greeting to the first user device,
wherein the voice greeting is played at the first user device.

11. A server system, comprising:
a memory; and
a processor coupled with the memory configured to:
receive a plurality of voice communication requests from a plurality of user devices;
generate user interface (UI) data comprising communication request information associated with the plurality of voice communication requests;
transmit the UI data to a plurality of agent devices, wherein a UI is presented on each of the plurality of agent devices based on the UI data, the UI comprises a plurality of selectable UI components corresponding to the plurality of voice communication requests, and each UI component includes communication request information associated with a corresponding voice communication request; and
initiate a first active voice communication, for a first voice communication request, between a first user device and a first agent device in response to receiving a service request from the first agent device to service the first voice communication request.

12. The server system of claim 11, wherein the first agent device sends the service request based on communication request information associated with the first voice communication request.

13. The server system of claim 11, wherein the processor is further configured to:
prior to the initiation of the first active voice communication, for the first voice communication request, between the first user device and the first agent device, determine that a first agent associated with the first agent device is available to service any of the plurality of voice communication requests.

14. The server system of claim 13, wherein the processor is further configured to:
receive a request from a second agent device associated with a second agent to join the first active voice communication after a first UI component corresponding to the first voice communication request is selected on the second agent device to present content associated with the first active voice communication; and
in response to receiving the request from the second agent device to join the first active voice communication, connecting the second agent device to the first active voice communication.

15. The server system of claim 11, wherein the communication request information of each UI component is obtained from a customer relation management (CRM) system.

16. The server system of claim 15, wherein the communication request information of each UI component includes a user status of a user associated with a user device and at least one of: a phone number of the user device, a state of the corresponding voice communication request, a start time, a duration associated with the corresponding voice communication request, or a name of the user associated with the user device.

17. The server system of claim 11, wherein the processor is further configured to:
after the initiation of the first active voice communication, for the first voice communication request, between the first user device and the first agent device, update a state of the first voice communication request from a first state to a second state, wherein communication request information associated with the first voice communication request comprises the state of the first voice communication request.

18. The server system of claim 11, wherein the processor is further configured to:
track and obtain metrics associated with a plurality of active voice communications that include the first active voice communication; and
send the metrics to the plurality of agent devices, wherein the metrics are displayed on the plurality of agent devices.

19. The server system of claim 11, wherein the processor is further configured to: during the first active voice communication, in response to detecting a connection drop between the first user device and the first agent device,
periodically attempt to reconnect the first user device with the first agent device, and
in response to successfully reconnecting the first user device with the first agent device, generate a greeting asking whether a user associated with the first user device wants to resume the first active voice communication, and send the greeting to the first user device,
wherein the greeting is presented at the first user device.

20. A non-transitory computer readable storage medium including instructions that, when executed by a processor, cause the processor to perform operations for real-time handling of active voice communications, the operations comprising:
receiving a plurality of voice communication requests from a plurality of user devices;
generating user interface (UI) data comprising communication request information associated with the plurality of voice communication requests;
transmitting the UI data to a plurality of agent devices, wherein a UI is presented on each of the plurality of agent devices based on the UI data, the UI comprises a plurality of selectable UI components corresponding to the plurality of voice communication requests, and each UI component includes communication request information associated with a corresponding voice communication request; and
initiating a first active voice communication, for a first voice communication request, between a first user device and a first agent device in response to receiving a service request from the first agent device to service the first voice communication request.
